(19) United States
(12) Patent Application Publication
(10) Pub. No.: US 2002/0049980 A1
(43) Pub. Date: Apr. 25, 2002

(54) Controlling data-on-demand client access

(76) Inventor: Khoi Nhu Hoang, Pleasanton, CA (US)

Correspondence Address: OPPENHEIMER WOLFF & DONNELLY, P. O. BOX 10356, PALO ALTO, CA, 94303, US

(21) Appl. No.: 09/902,503

(22) Filed: Jul. 9, 2001

Related U.S. Application Data
(63) Continuation-in-part of application No. 09/584,832, filed on May 31, 2000.
(63) Continuation-in-part of application No. 09/709,948, filed on Nov. 10, 2000.
(63) Continuation-in-part of application No. 09/841,792, filed on Apr. 24, 2001.
(63) Continuation-in-part of application No. 09/870,879, filed on May 30, 2001.
(63) Continuation-in-part of application No. 09/892,015, filed on Jun. 25, 2001.

(51) Int. Cl. H04N 7/173

(52) U.S. Cl. 725/91

(57) ABSTRACT

The present invention teaches a method for controlling client access to DOD services, comprising: receiving a subscription data packet including at least one associated client identification code, at least one associated subscription level code, and at least one associated service level code; and storing at least a portion of the at least one associated subscription level code in a memory location; storing the at least one associated service level code in a memory location; receiving a first service having a subscription level; and wherein the subscription level code corresponds to the subscription level, accessing the first service. The method further includes: receiving a second service having at least one associated service level; and wherein the at least one associated service level code corresponds to the at least one associated service level, accessing at least a portion of the second service.

### RELATED APPLICATIONS

This application is a continuation-in-part claiming priority to Khoi Nhu Hoang's patent applications entitled COUNTERFEIT STB PROTECTION THROUGH PROTOCOL SWITCHING filed on Jun. 25, 2001, UNIVERSAL STB ARCHITECTURES AND CONTROL METHODS filed on May 30, 2001, SYSTEMS AND METHODS FOR PROVIDING VIDEO ON DEMAND SERVICES FOR BROADCASTING SYSTEMS filed on May 31, 2000, bearing application Ser. No. 09/584,832, METHODS FOR PROVIDING VIDEO ON DEMAND SERVICES FOR BROADCASTING SYSTEMS filed Nov. 10, 2000, bearing application Ser. No. 09/709,948 and UNIVERSAL DIGITAL BROADCAST SYSTEM AND METHODS filed on Apr. 24, 2001, bearing application Ser. No. 09/841,792, all three being incorporated herein by reference.

### BACKGROUND OF THE INVENTION

1. Field of the Invention

The present invention relates to data-on-demand (DOD) and digital broadcast technology. In particular, the present invention teaches a method and apparatus for controlling client access to DOD services.

2. Description of the Prior Art

A variety of mechanisms are available for controlling the access of data-on-demand (DOD) clients to DOD services through set top boxes (STB) for receiving DOD programs for display on a television or other video display device. One problem faced in the video-on-demand (VOD) and DOD industry is controlling the access of a client's STB to DOD programs without using bi-directional communications. Traditional uni-directional communications, such as cable, have had many problems in controlling what services selected clients could access. The advent of the STB allowed a mixed signal to be sent with some programs being scrambled in order to allow only clients with special STBs to receive these programs. However, this allowed clients who were delinquent in their payments to continue to receive service and made it difficult to change levels of service without exchanging STBs. Using bi-directional communications allowed for DOD programs to be sent to individual clients, however this would use significant processing and bandwidth resources and will not work in unidirectional systems.

The following is a general discussion of widely used digital broadcast systems. Generally in digital broadcast systems, a bit stream, multiplexed in accordance with the MPEG-2 standard, is a “transport stream” constructed from “packetized elementary stream” (or PES) packets and packets containing other necessary information. A “packetized elementary stream” (or PES) packet is a data structure used to carry “elementary stream data.” An “elementary stream” is a generic term for one of (a) coded video, (b) coded audio, or (c) other coded bit streams carried in a sequence of PES packets with one stream ID. Transport streams support multiplexing of video and audio compressed streams from one program with a common time base.

PRIOR ART FIG. 1 illustrates the packetizing of compressed video data 106 of a video sequence 102 into a stream of PES packets 108, and then, into a stream of transport stream packets 112. Specifically, a video sequence 102 includes various headers 104 and associated compressed video data 106. The video sequence 102 is parsed into variable length segments, each having an associated PES packet header 110 to form a PES packet stream 108. The PES packet stream 108 is then parsed into segments, each of which is provided with a transport stream header 114 to form a transport stream 112.

PRIOR ART FIG. 2 is a block schematic showing a digital broadcast system 200 including a digital broadcast server 202 and a set-top-box 204 suitable for processing digital broadcast data. At the digital broadcast server 202, video data is provided to a video encoder 206 which encodes the video data in accordance with the MPEG-2 standard. The video encoder 206 provides encoded video 208 to a packetizer 210 which packetizes the encoded video 208. The packetized encoded video 212 provided by the packetizer 210 is then provided to a transport stream multiplexer 214.

Similarly, at the digital broadcast server 202, audio data is provided to an audio encoder 214 which encodes the audio data. The audio encoder 214 provides encoded audio 218 to a packetizer 220 which packetizes the encoded audio 218. The packetized encoded audio 222 provided by the packetizer 220 is then provided to the transport stream multiplexer 214.

The transport stream multiplexer 214 multiplexes the encoded audio and video packets and transmits the resulting multiplexed stream to a set-top-box 204 via distribution infrastructure 224. This distribution infrastructure 224 may be, for example, a telephone network and/or a cable TV (CATV) system, employing optical fiber and implementing asynchronous transfer mode (ATM) transmission protocols. At the set-top-box 204, on a remote end of the distribution infrastructure 224, a transport stream demultiplexer 230 receives the multiplexed transport stream. Based on the packet identification number of a particular packet, the transport stream demultiplexer 230 separates the encoded audio and video packets and provides the video packets to a video decoder 232 via link 238 and the audio packets to an audio decoder 236 via link 240.

The transport stream demultiplexer 230 also provides timing information to a clock control unit 236. The clock control unit 236 provides timing outputs to the both the video decoder 232 and the audio decoder 236 based on the timing information provided by the transport stream demultiplexer 230 (e.g., based on the values of PCR fields). The video decoder 232 provides video data which corresponds to the video data originally provided to the video encoder 206. Similarly, the audio decoder 236 provides audio data which corresponds to the audio data originally provided to the audio encoder 216.

PRIOR ART FIG. 3 shows a simplified functional block diagram of a VOD system 300. At the heart of the VOD system 300 is the video server 310 which routes the digital movies, resident in the movie storage system 312, to the distribution infrastructure 314. This distribution infrastructure 314 may be, for example, a telephone network and/or a cable TV (CATV) system, employing optical fiber and implementing asynchronous transfer mode (ATM) transmission protocols. The distribution infrastructure 314 delivers movies to individual homes based on the routing information supplied by the video server 310.

The VOD system 300 also includes a plurality of VOD STBs 304 suitable for processing VOD in the VOD system 300. Each STB 304 receives and decodes a digital movie and converts it to a signal for display on a TV set or A/V monitor.

The typical model for digital broadcast and DOD systems described above adheres to what is termed a “bi-directional client-server model.” In order to point out defects inherent to this prior art system, the typical hardware architecture generic to such a DOD system will be described below with reference to FIG. 4. Further, a pair of methods for controlling the prior art DOD server and the prior art DOD client will be described below with reference to FIG. 5 and FIG. 6, respectively.

PRIOR ART FIG. 4 illustrates a general diagram of a DOD system 320 having a bi-directional client-server architecture. The DOD system 322 includes a DOD server 322 bi-directionally coupled with a plurality of DOD clients 324 via communication link 326. As will be appreciated, the VOD system 300 of FIG. 3 is a somewhat specific example of the DOD system 320.

Broadly speaking, the DOD system 320 operation adheres to the well known client-server model as follows. In some manner, typically through transmission of an Electronic Program Guide (EPG) by the DOD server 322, the clients 324 are informed of available on-demand data. Using the EPG for reference, a requesting DOD client 324 requests specific data from the DOD server 322 via the communication link 326. The DOD server 322 interprets the client request, and then prepares the client specific data in a format suitable for use by the requesting client 324.

Once the client specific data is prepared, the server 322 transmits the client specific data to the requesting client 324. The requesting client 324 receives, via a specifically allocated portion of the communication link 326, the requested client specific data in a readably usable format. The requested client specific data is provided in a format ready for presentation by the DOD client to the end user. These client-server processes are described below in more detail with reference to FIGS. 5-6.

Under the client-server model of FIG. 4, the available bandwidth of communication link 326 must be divided up into allocated portions 328, each allocated portion being dedicated to a particular client. Hence the bandwidth required for prior art DOD systems is directly proportional to the number of clients being served.

Although communication link 326 may be a true bi-directional communications medium, such infrastructure is uncommon. Instead, typical implementations today cobble together existing infrastructure such as fiber optic cabling and telephone lines to implement the necessary bi-directional communications. For example, the fiber optic cable may be used for server transmission of client specific data while an existing telephone line may be used for client transmission of requests.

Turning next to PRIOR ART FIG. 5, a bi-directional DOD server method 340 in accordance with the prior art will now be described. In a first step 342, the DOD server identifies the available slots within the available transmission bandwidth. In a next step 344 the DOD server prepares and transmits a suitable EPG to each client. It will be appreciated that different EPGs may be transmitted for different clients depending upon factors such as subscription levels, available services, personalized settings, payment history, etc. In any event, in a next step 346, the DOD server receives a demand for specific data from a specific client. The demand includes information indicating the identity of the client. Then in a step 348, the DOD server identifies the specific client from information included with the demand.

At a step 350, a determination is made whether the client is authorized to receive the requested data. This determination is made at the DOD server 322 (FIG. 4), where each DOD service has an assigned subscription level requirement. The DOD server compares a client's subscription level stored in the clients data file to the requested service's subscription level requirement. This determination generally requires many complex independent operations, and is described here in only in a very simplified manner.

If the client's subscription level corresponds with the subscription level of the requested data, then the client is authorized to receive the data. If the client is authorized to receive the data requested, the process proceeds to step 351. In step 351, the DOD server assigns an available slot to the authentic client. In step 352, the DOD server prepares the requested client specific data for transmission in a format suitable for the requesting client. Step 348 may include such actions as retrieving the client specific data from a persistent storage mechanism and preparing an appropriate channel server for data transmission. Continuing with a step 354, the DOD server transmits the client specific data via the bandwidth allocated to the requesting client.

If the client is not authorized to receive the requested data, the process proceeds to step 356, where the DOD server transmits a generic message stating that the service is unavailable. Other appropriate data may also be transmitted.

Turning next to FIG. 6, a client method 360 for retrieving on-demand data will now be described. In a tuning step 362, the DOD client will tune into the appropriate channel program and in a receiving step 364 the DOD client will receive the EPG transmitted by the DOD server. In a next step 366, the DOD client provides the EPG information to a DOD user and in a step 368, receives a request for specific data from the DOD user. Then in a step 370, the DOD client demands that the DOD server provide the requested client specific data. In a step 372, in anticipation of the requested client specific data, the DOD client tunes into the allocated bandwidth. Then in a step 374, the DOD client receives via allocated bandwidth the requested client specific data in a readably usable format and provides it to the DOD user.

As the above discussion reflects, none of the prior art systems provide a method for easily controlling a client's access to DOD services without bi-directional communication. Therefore, it is desirable to provide a method for preventing delinquent clients from accessing data from a DOD system without relying on bi-directional communication. Furthermore, it is desirable to provide a method for altering a DOD clients subscription level without bi-directional communication or altering the clients STB. What is also needed is a method for communicating a client's DOD account status to a client using unidirectional communications.

### SUMMARY

The present invention teaches methods and systems for preventing delinquent clients from accessing data from a DOD system without relying on bi-directional communication. The present invention also teaches methods and systems for altering a DOD clients subscription level without bi-directional communication or altering the clients STB. Additionally, the present invention teaches methods and systems for communicating a client's DOD account status to a client using unidirectional communications. These include a universal digital data system, a universal STB, and a variety of methods for handling these digital services and controlling the universal STB.

A first embodiment of the present invention teaches a method for controlling client access to DOD services using only unidirectional communication, comprising the acts of: receiving at least one subscription data packet including at least one associated client identification code, at least one associated subscription level code, and at least one associated service level code; and storing at least a portion of the at least one associated subscription level code in a memory location; storing at least a portion of the at least one associated service level code in a memory location; receiving at least one first service having at least one associated subscription level; and wherein the at least one associated subscription level code corresponds to the at least one associated subscription level, accessing at least a portion of the first service. The method further includes: receiving at least one second service having at least one associated service level; and wherein the at least one associated service level code corresponds to the at least one associated service level, accessing at least a portion of the second service. Wherein the subscription data packet includes at least one associated warning level code, displaying a warning message associated with the warning level code.

It is important to remark that as types of set-top boxes become more ubiquitous, they are often built-in to a unit, such as a TV or computer, rather than actually set on top or beside. One of ordinary skill in the art would recognize that all references to STBs would apply equally to built-in version, and thus the two become synonymous.

### BRIEF DESCRIPTION OF THE DRAWINGS

PRIOR ART FIG. 1 illustrates pictorially the packetizing of compressed video data into a stream of packets and a stream of transport packets;

PRIOR ART FIG. 2 illustrates by block diagram a system according to the MPEG-2 standard;

PRIOR ART FIG. 3 illustrates a simplified functional block diagram of a VOD system;

PRIOR ART FIG. 4 illustrates a DOD system adhering to a prior art bi-directional client-server architecture;

PRIOR ART FIG. 5 illustrates a DOD server method for controlling the receipt of DOD services by clients using a bi-directional, client specific data transmission mechanism;

PRIOR ART FIG. 6 illustrates a DOD client method for receiving and processing client specific data via a bi-directional transmission mechanism;

FIG. 7 is a block diagram of a digital broadcast server in accordance with one embodiment of the present invention;

FIG. 8 is a block diagram showing the hardware architecture of a universal STB in accordance with yet another embodiment of the present invention;

FIG. 9 is a schematic block diagram illustrating a subscription level data block in accordance with one embodiment of the present invention;

FIG. 10 is a flow chart illustrating a computer implemented method for controlling the subscription level of an STB in accordance with the present invention;

FIG. 11 is a flow chart illustrating a computer executable method for accessing selected DOD services having an associated subscription level in accordance with the present invention;

FIG. 12A is schematic block diagram illustrating a subscription level data block in accordance with one embodiment of the present invention;

FIG. 12B is schematic block diagram illustrating a subscription level data block in accordance with an alternative embodiment of the present invention;

FIG. 12C is schematic block diagram illustrating a subscription level data block in accordance with another alternative embodiment of the present invention;

FIG. 13A is schematic block diagram illustrating a service level data block in accordance with one embodiment of the present invention;

FIG. 13B is schematic block diagram illustrating a service level data block in accordance with an alternative embodiment of the present invention;

FIG. 14 is a flow chart illustrating a computer executable method for accessing selected DOD services having an associated service level in accordance with the present invention;

FIG. 15 is schematic block diagram illustrating a warning level data block in accordance with one embodiment of the present invention; and

FIG. 16 is a flow chart illustrating a computer implemented method for displaying a warning message in accordance with the present invention.

### DETAILED DESCRIPTION OF THE PREFERRED EMBODIMENTS

In the following detailed description of the embodiments, reference is made to the drawings that accompany and that are a part of the embodiments. The drawings show, by way of illustration, specific embodiments in which the invention may be practiced. Those embodiments are described in sufficient detail to enable those skilled in the art to practice the invention and it is to be understood that other embodiments may be utilized and that structural, logical, and electrical changes as well as other modifications may be made without departing from the spirit and scope of the present invention.

The present invention teaches methods and systems for preventing delinquent clients from viewing data from a unidirectional DOD system by displaying a warning message over displayed DOD data. The present invention also teaches methods and systems for altering a DOD clients subscription level without bi-directional communication or altering the clients STB. A client's subscription level indicates the number of DOD services a client has access to. Generally the client must pay a higher monthly fee for a higher subscription level, which would allow access to more DOD services. Additionally, the present invention teaches methods and systems for communicating a client's DOD account status to a client using uni-directional communications. These include a universal digital data system, a universal STB, and a variety of methods for handling these digital services and controlling the universal STB. However, those skilled in the art will recognize that all aspects of the present invention can be implemented within the bi-directional communication paradigm, the only difference being that even more features can be provided to the digital broadcast and DOD user when a bi-directional communication link is available.

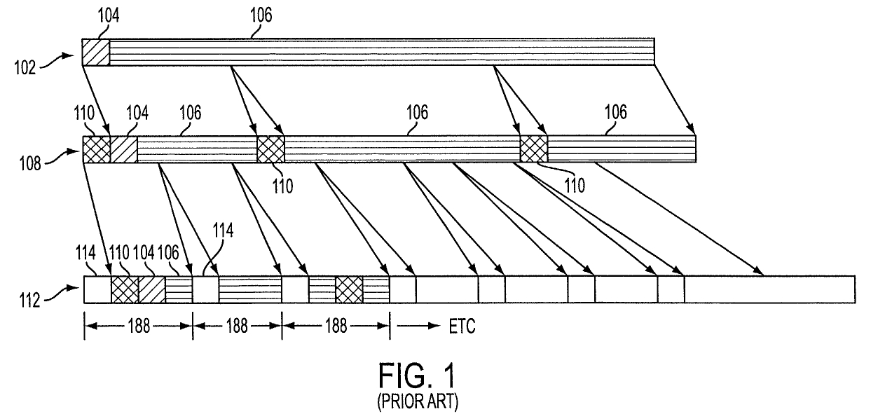

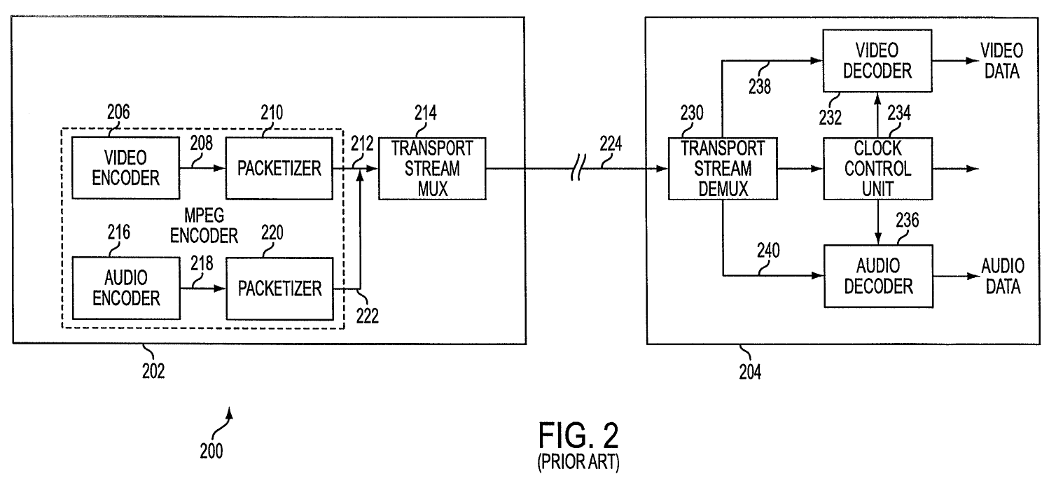

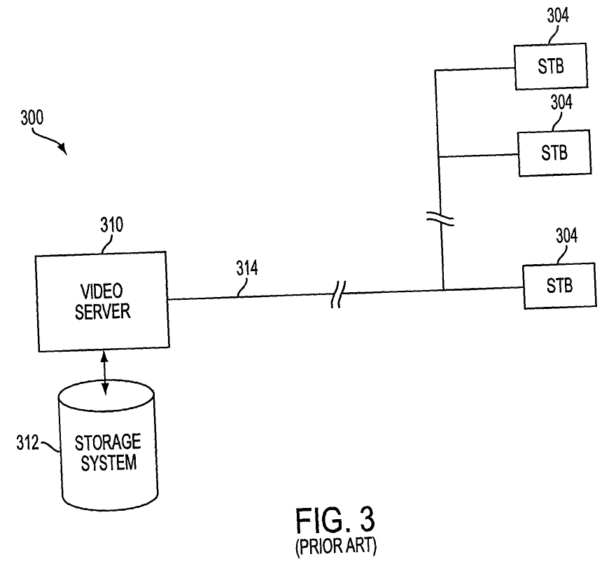

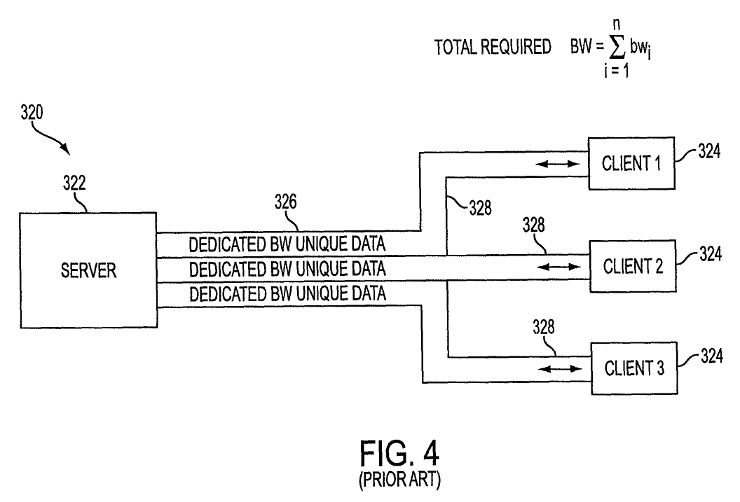

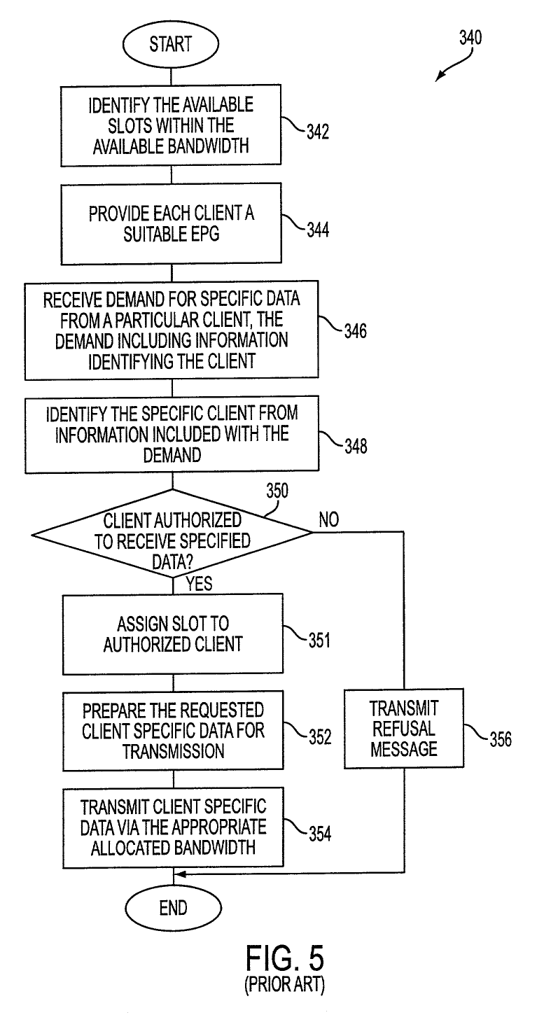

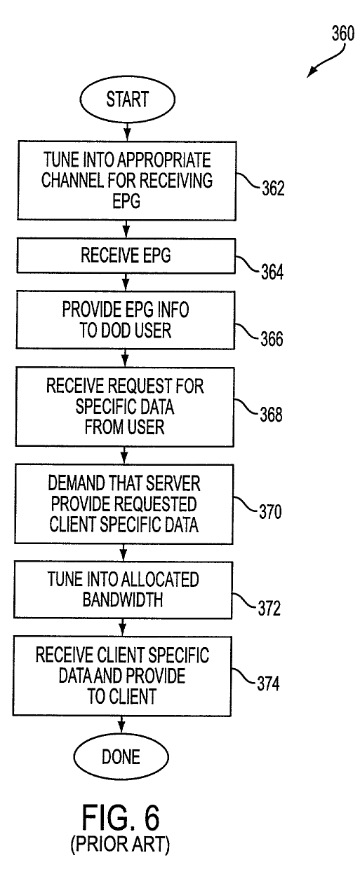

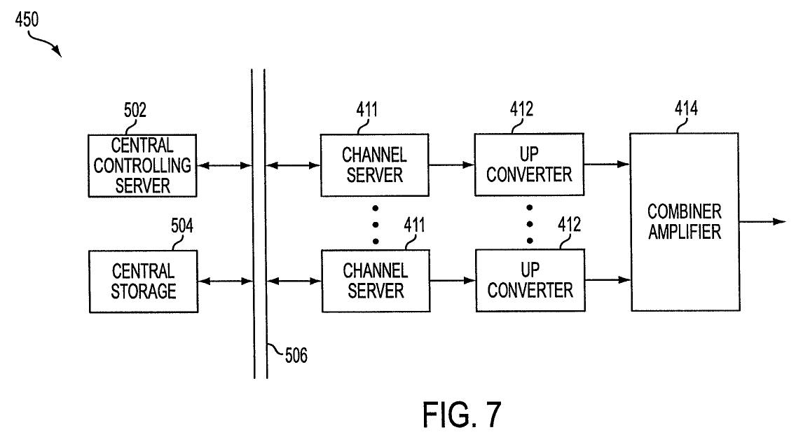

FIG. 7 illustrates the architecture for a DOD server 450 in accordance with one embodiment of the present invention. The DOD server 450 includes a plurality of channel servers 411, a plurality of up converters 412 each corresponding to a channel server 411, a combiner amplifier 414, a central controlling server 502, and a central storage 504, coupled as illustrated through a data bus 506. As will be described below, the central controlling server 502 controls off-line operation of the channel servers 411, as well as initiating real-time transmission once the channel servers 411 are ready. The central storage 504 typically stores data files in a digital format. However, any suitable mass persistent data storage device may be used.

In an exemplary embodiment, data files stored in the central storage 504 are accessible via a standard network interface (e.g., Ethernet connection) by any authorized computer, such as the central controlling server 502, connected to the network. The channel servers 411 provide data files that are retrieved from the central storage 504 in accordance with instructions from the central controlling server 502. The retrieval of digital data and the scheduling of transmission of the digital data for DOD is performed “off-line” to fully prepare each channel server 411 for real-time data transmission. Each channel server 411 informs the central controlling server 502 when ready to provide DOD, at which point the central controlling server 502 can control the channel servers 411 to begin DOD transmission.

In a preferred embodiment, the central controlling server 502 includes a graphics user interface (not shown) to enable a service provider to schedule data delivery by a drag-and-drop operation. Further, the central controlling server 502 authenticates and controls the channel servers 410 to start or stop according to delivery matrices. Systems and methods for providing uni-directional DOD broadcast matrices are taught in Khoi Hoang's patent application entitled SYSTEMS AND METHODS FOR PROVIDING VIDEO ON DEMAND SERVICES FOR BROADCASTING SYSTEMS filed on May 31, 2000, bearing application Ser. No. 09/584,832, which is incorporated herein by reference.

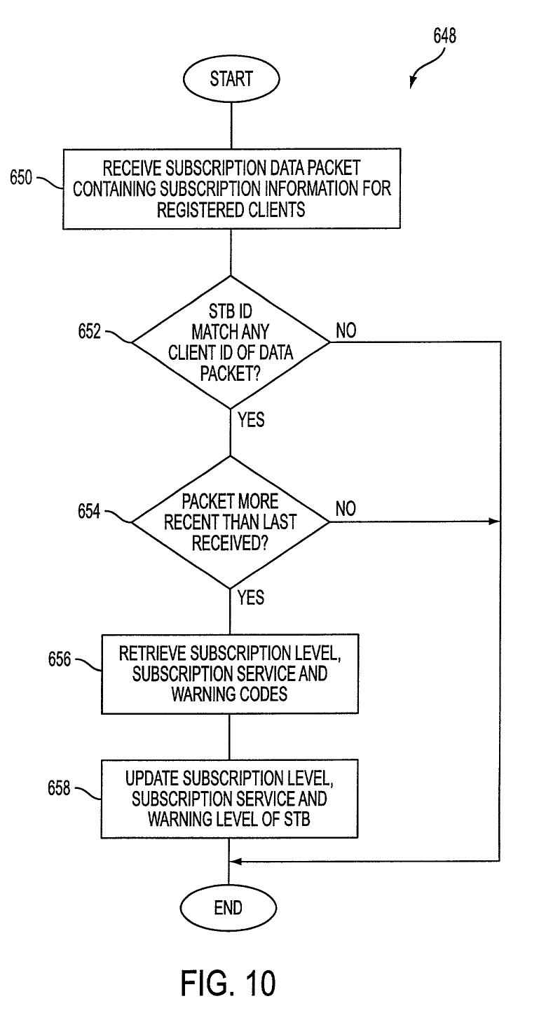

Each channel server 411 is assigned to a channel and is coupled to an up-converter 412. The output of each channel server 411 is a quadrature amplitude modulation (QAM) modulated intermediate frequency (IF) signal having a suitable frequency for the corresponding up-converter 412. The QAM-modulated IF signals are dependent upon adopted standards. The current adopted standard in the United States is the data-over-cable-systems-interface-specification (DOCSIS) standard, which requires an approximately 43.75 MHz IF frequency. A preferred channel server 411 is described below in more detail with reference to FIG. 10.

The up-converters 412 convert IF signals received from the channel servers 104 to radio frequency signals (RF signals). The RF signals, which include frequency and bandwidth, are dependent on a desired channel and adopted standards. For example, under the current standard in the United States for a cable television channel 80, the RF signal has a frequency of approximately 559.25 MHz and a bandwidth of approximately 6 MHz.

The outputs of the up-converters 412 are applied to the combiner/amplifier 414. The combiner/amplifier 414 amplifies, conditions and combines the received RF signals then outputs the signals out to a transmission medium.

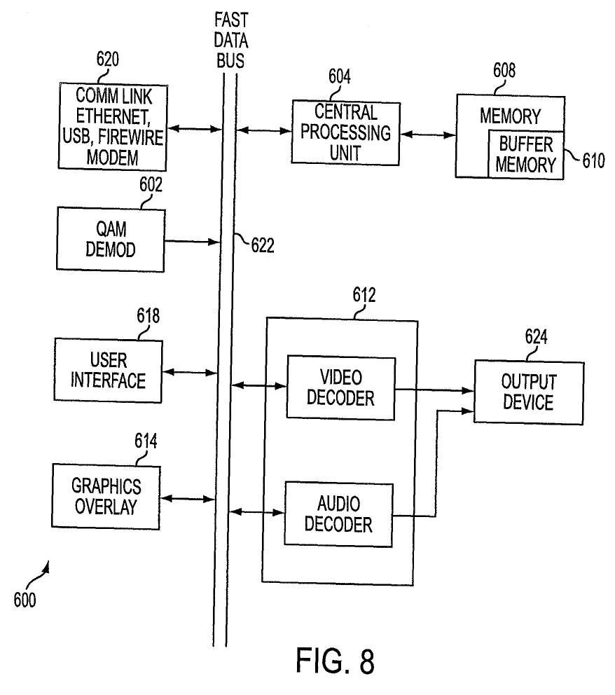

FIG. 8 illustrates a universal STB 600 in accordance with one embodiment of the invention. The STB 600 comprises a QAM demodulator 602, a CPU 604, a local memory 608, a buffer memory 610, a decoder 612 having video and audio decoding capabilities, a graphics overlay module 614, a user interface 618, a communications link 620, and a fast data bus 622 coupling these devices as illustrated. The CPU 602 controls overall operation of the universal STB 600 in order to select data in response to a client's request, decode selected data, decompress decoded data, re-assemble decoded data, store decoded data in the local memory 608 or the buffer memory 610, and deliver stored data to the decoder 612. In an exemplary embodiment, the local memory 608 comprises both non-volatile memory (e.g., a hard drive) and secure memory (e.g., a ROM chip), and the buffer memory 610 comprises volatile memory. A hardware identification code (not shown) is stored in a secure memory location of the local memory 608, this code is unique to the STB 600 and cannot be readily altered. An STB subscription level code is stored in a non-volatile memory location of the local memory 608, and is needed to access DOD programs.

In one embodiment, the QAM demodulator 602 comprises transmitter and receiver modules and one or more of the following: privacy encryption/decryption module, forward error correction decoder/encoder, tuner control, downstream and upstream processors, CPU and memory interface circuits. The QAM demodulator 602 receives modulated IF signals, samples and demodulates the signals to restore data.

In an exemplary embodiment, when access is granted, the decoder 612 decodes at least one data block to transform the data block into images displayable on an output screen. The decoder 612 supports commands from a subscribing client, such as play, stop, pause, step, rewind, forward, etc. The decoder 612 provides decoded data to an output device 624 for use by the client. The output device 624 may be any suitable device such as a television, computer, any appropriate display monitor, a VCR, or the like.

The graphics overlay module 614 enhances displayed graphics quality by, for example, providing alpha blending or picture-in-picture capabilities. In an exemplary embodiment, the graphics overlay module 614 can be used for graphics acceleration during game playing mode, for example, when the service provider provides games-on-demand services using the system in accordance with the invention.

The user interface 618 enables user control of the STB 600, and may be any suitable device such as a remote control device, a keyboard, a smartcard, etc. The communications link 620 provides an additional communications connection. This may be coupled to another computer, or may be used to implement bi-directional communication. The data bus 622 is preferably a commercially available “fast” data bus suitable for performing data communications in a real time manner as required by the present invention. Suitable examples are USB, firewire, etc. Although services are broadcast to all cable television subscribers, only the DOD subscriber who has an STB 600 authorized to view a selected DOD service will be able to decode and enjoy the selected service.

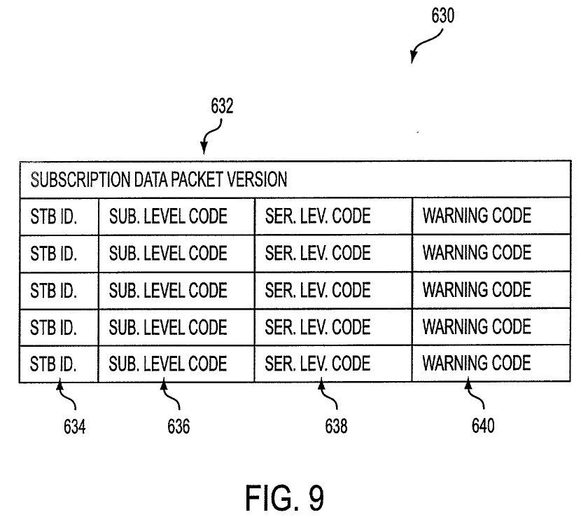

FIG. 9 shows a subscription data packet at 630 for controlling what DOD services are available to selected clients in accordance with one embodiment of the present invention. A subscription data packet 630 is sent to all clients via the packet data stream 112 (FIG. 1). The subscription data packet 630 includes: a version identifier 632, a plurality of client identification codes 634; a plurality of client subscription level codes 636; a plurality of subscription service codes 638; and a plurality of warning codes 640. Each STB 600 (FIG. 8) is provided with the subscription level code 636, subscription service code 638 and warning code 640 associated with that client's client identification code 634. When a client changes subscription level or subscription services a new subscription data packet is created with the codes associated with that client reflecting the change in services. In this way a DOD service provider can control exactly what DOD services each client may access. The subscription data packet 630 is transmitted at some regular time interval, for example once every 5 minutes. It is desirable to send the packet as frequently as practicable, but more frequent transmissions require more of the available transmission band width.

In one embodiment each subscription data packet 630 has a version code 632 associated with the packet. An STB 600 (FIG. 8) receiving a data packet 630 with a version code 632 that it has previously received will not store information from that previously received data packet. In this way the STB will not use processing resources to update itself unnecessarily.

In one embodiment a plurality of subscription data packets 630 are transmitted, wherein each packet has subscription information for less than all of the registered DOD system clients. This reduces the necessary size of subscription packets 630 by allowing the DOD system subscription information transmitted to be distributed among a plurality of packets 630.

Each client STB receives every subscription data packet, but only an STB having a hardware identification code (not shown) corresponding to a selected client identification code 634 may access the subscription level code 636, subscription service code 638 and warning code 640 associated with that client. An STB not having a hardware identification code corresponding to any of the client codes contained in the subscription data packet cannot access any of the subscription level codes or subscription service codes. In this way each STB 600 (FIG. 8) may only access the subscription level code and subscription service code associated with that STB. The hardware identification code is located at a location within the STB 600 (FIG. 8). Each STB has a unique hardware identification code. The client identification code allows an STB having a corresponding hardware identification code to access the associated subscription level code, subscription service code and warning code in a subscription data packet.

In accordance with one embodiment DOD services associated with network and premium television channels are assigned subscription levels, whereas individual movies, sporting events, publications and games are assigned service levels. This allows more flexibility in ordering one time viewing of certain desired DOD services with the use of the service level code, while maintaining a level of base line service with the subscription level code. Of course it may also be desirable to assign both a service level and a subscription level to each available DOD service in order to provide maximum flexibility.

In an alternative embodiment each subscription data packet includes only client identification codes and subscription level codes, wherein the packet includes a client identification code corresponding to each STB registered to receive service. A client having more than one STB 600 (FIG. 8) for receiving transmissions would be assigned a plurality of client identification codes. In accordance with this embodiment, each subscription data packet is structured as follows:

SUBSCRIPTION DATA PACKET VERSION

| | |
|---|---|
| STB ID. | SUBSCRIPTION LEVEL CODE |
| STB ID. | SUBSCRIPTION LEVEL CODE |
| STB ID. | SUBSCRIPTION LEVEL CODE |

In yet another alternative embodiment, each subscription data packet includes only a client identification code and a warning code. In such an embodiment the warning code is used to control access to DOD program data. The implementation of warning levels is discussed in greater detail below.

FIG. 10 shows a process for updating client level of access to DOD programs at 648 in accordance with one embodiment of the present invention. The process 648 begins at step 650, in which an STB 600 (FIG. 8) receives a subscription data packet 630 (FIG. 9) from the server 450 (FIG. 7). The data packet is transmitted via different channels randomly so that each STB will receive the data packet regardless of what channels are accessed. Generally the data packets will be interspersed with regularly transmitted DOD data files.

In a step 652 the STB determines whether the STB hardware identification code matches any of the client identification codes included in the subscription data packet 630 (FIG. 9). The STB hardware identification code is unique, and corresponds to a client registered to receive DOD services. A client with multiple STBs will be assigned multiple client identification codes, each corresponding to a single STB.

If the STB hardware identification code matches one of the client identification codes contained in the subscription data packet, then in step 654 the STB determines whether the subscription data packet version 632 (FIG. 9) is more recent than the last packet used to update the STB.

In step 656 the STB retrieves the subscription level code 636, subscription service code 638 and warning code 640 corresponding to the client identification code 634 associated with the STB. In a step 658 the STB updates the subscription level, subscription service and warning level of the STB. This may involve simply over writing previous levels stored in memory 608 (FIG. 8), or may require a more complex process of updating the STB's software.

If in step 652, the STB ID does not match any of the IDs stored in the subscription data packet 630 (FIG. 9), the STB subscription, service and warning levels are not updated. Similarly, if in step 654, the subscription data packet has a version that is not newer than the last version received, the STB subscription, service and warning levels are not updated.

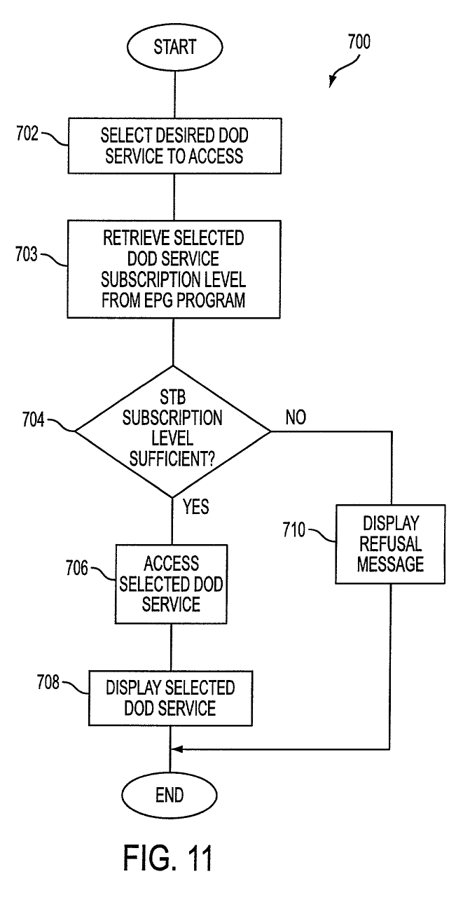

FIG. 11 shows an STB process for accessing DOD services at 700 in accordance with one embodiment of the present invention. The process begins at step 702, in which a user selects a DOD service to be accessed using the user interface 618 (FIG. 8). This may involve selecting a program for viewing from a listing of available DOD programs on the EPG. A service may also be selected by entering a code corresponding to the desired service. In accordance with one embodiment each DOD service has a subscription level accessible on the EPG program. In accordance with another embodiment, DOD subscription programs are limited to DOD services such as television channels, whereas selected DOD services such as games, publications and special events are reserved for access via the service level code 638 (FIG. 9).

In a step 703, the STB retrieves the subscription level corresponding to the selected DOD service from the EPG program. With the data associated with each DOD service included in the EPG program is included an associated subscription level corresponding to that DOD program. The STB searches for the selected program data contained in the EPG program and retrieves the corresponding subscription level.

In an alternative embodiment the subscription level of a selected DOD service is contained in each header 104 (FIG. 1) associated with that service. In such an embodiment the STB retrieves the selected DOD service's subscription level directly from a header 104 of the selected DOD program.

In step 704, the STB 600 (FIG. 8) determines whether the STB subscription level is sufficient to access the selected DOD program. The STB 600 (FIG. 8) retrieves a selected DOD services subscription level from the EPG program. An STB's subscription level is sufficient to access a selected DOD service if it is greater than or equal to the subscription level of the selected service.

If the STB subscription level is sufficient the process continues to step 706, in which the STB accesses the selected DOD service. In step 708 the STB displays any graphical elements of the selected DOD service on an A/V monitor or television set.

If the STB subscription level is found to be insufficient, the process continues to a step 710. At step 710 the STB displays a refusal message to the user.

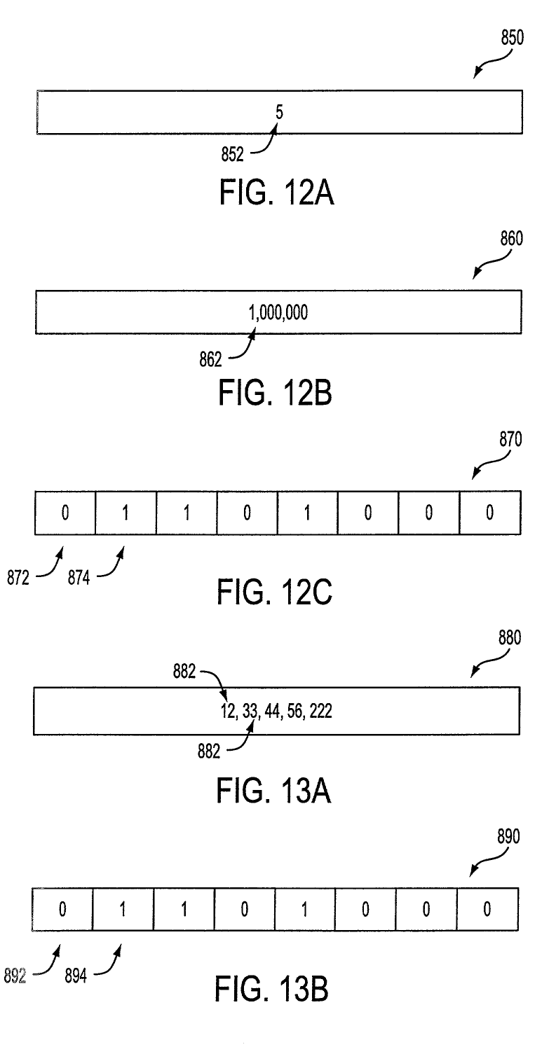

FIG. 12A shows a subscription level data block at 850 in accordance with one embodiment of the present invention. The subscription level data block 850 contains a single subscription level 852 ranging from 1-10. Each subscription level represents a different level of access to DOD services. An STB having a subscription level could access and display any DOD service having a subscription level less than or equal to the STB′ subscription level. For example, a client with a subscription level of 5 could view any DOD service having a subscription level of 1-5. For example, in step 706 (FIG. 11), if HBO had a subscription level of 4, an STB with a subscription level of 5 would be found to be sufficient for viewing HBO. Generally a level 1 subscription would allow access to most commercial television channels such as NBC, TNT, etc., and a level 10 subscription would allow access to all premium channels available from the server.

FIG. 12B shows a subscription level data block at 860 in accordance with another embodiment of the present invention. The subscription level data block 860 contains a single numerical value 862. The value 862 indicates the subscription level of a selected client or STB 600 (FIG. 8). In this embodiment each STB can only have one subscription level 862, wherein an increase in the subscription level corresponds with one more DOD service available to a client. For example, the premium service HBO may be viewed by a first STB having a subscription level of 10,000, but not by a second STB having a subscription level of 9,999.

FIG. 12C shows a subscription level data block at 870 in accordance with another embodiment of the present invention. The subscription level data block 870 is composed of a bit index with 8 binary values. A first bit 872 corresponds to a first subscription service. A subscription service may correspond to one or more DOD services such as movies or video games, or one or more network television channels, etc. The first bit 872 has a value of zero, which indicates to the STB 600 (FIG. 8) that these services may not be displayed, and that the client would not have a sufficient subscription level to view these programs as determined in step 706 (FIG. 11). For example, if the first bit 872 corresponded with HBO1 and HBO2, the client would not be authorized to view HBO1 and HBO2.

A second bit 874 corresponds with a second subscription service. For example, second bit 854 corresponds to the NBC, ABC and CBS networks. The second bit 874 contains a value of 1, which indicates to the STB 600 (FIG. 8) that these services may be displayed, and that the client would have a sufficient subscription level to view these programs as determined in step 706 (FIG. 11).

FIG. 13A shows a service level data block at 880 in accordance with one embodiment of the present invention. In this embodiment the subscription service data block 880 contains multiple values 882, with each value corresponding to an individual DOD service or group of DOD services. The receiving STB would be able to access each DOD service that corresponded to a value contained in the STB's service level code. For example, a service level code consisting of 12, 33, 44, 56, 222 would enable access to five different DOD services corresponding to the five values.

FIG. 13B shows a service level data block at 890 in accordance with one embodiment of the present invention. In this embodiment the subscription service data block 890 is composed of a bit index with 8 binary values. A first bit 892 corresponds to a first subscription service. A subscription service may correspond to one or more DOD services such as movies or video games, etc. The first bit 892 has a value of zero, which indicates to the STB 600 (FIG. 8) that these services may not be displayed, and that the client would not have the required service level to access these services. For example, if the first bit 892 corresponded with the movie “Star Wars”, the client would not be authorized to view this movie.

A second bit 894 corresponds with a second DOD service. For example, second bit 894 corresponds to the video game “Final Fantasy IV”. The second bit 894 contains a value of 1, which indicates to the STB 600 (FIG. 8) that this service may be accessed.

A DOD service's service level is retrieved from the EPG program, just as a DOD services subscription level was retrieved in step 703 (FIG. 11). Alternatively, each packet header 110 (FIG. 1) containing a portion of a DOD service includes a service level 638, and may only be accessed by an STB having a corresponding service level code. Different DOD services may have the same service level.

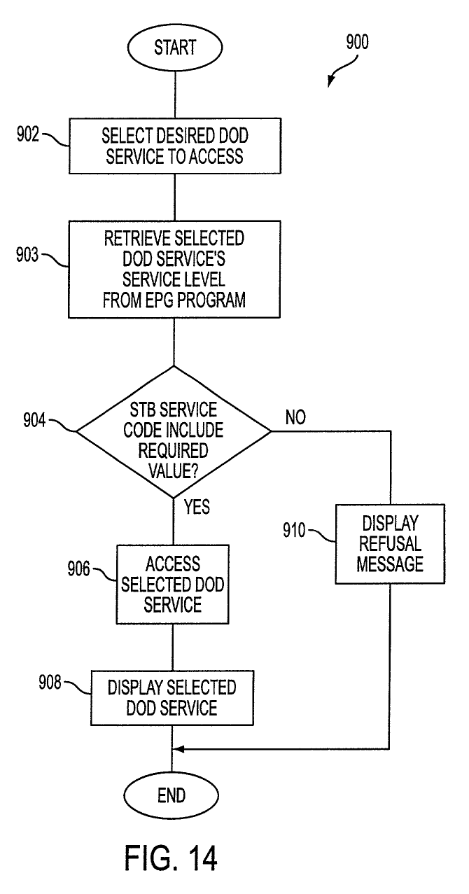

FIG. 14 shows an STB process for accessing DOD services at 900 in accordance with one embodiment of the present invention. The process begins at step 902, in which a user selects a DOD service to be accessed using the user interface 618 (FIG. 8). This may involve selecting a program for viewing from a listing of available DOD programs on the EPG. A service may also be selected by entering a code corresponding to the desired service. In accordance with one embodiment each DOD service has a service level accessible by the STB via the EPG program.

In a step 903, the STB retrieves the service level corresponding to the selected DOD service from the EPG program. In step 904, the STB 600 (FIG. 8) determines whether the STB service level code includes a code corresponding to the selected DOD service.

If the STB service level includes a value corresponding to the selected DOD service the process continues to step 906, in which the STB accesses the selected DOD service. In step 908 the STB displays any graphical elements of the selected DOD service on an A/V monitor or television set.

If the STB service level does not contain a value corresponding to the selected DOD service, the process continues to a step 9 10. At step 910 the STB displays a refusal message to the user.

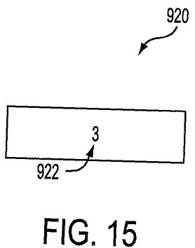

FIG. 15 shows a warning level data block at 920 in accordance with one embodiment of the present invention. The warning level data block 920 included with each subscription data packet 630 (FIG. 9) may contain a value 922 ranging from 0 to 3. A 0 value indicates that the client's account is current. A value of 1 indicates that the client is 30 days overdue on his payment. A value of 2 indicates a 60 day delinquency. A value of 3 indicates that the client is seriously delinquent and should be blocked from receiving DOD services. For example, the warning level data block 920 contains a value of 3, indicating that the client is seriously delinquent in payments, and that his viewing should be blocked.

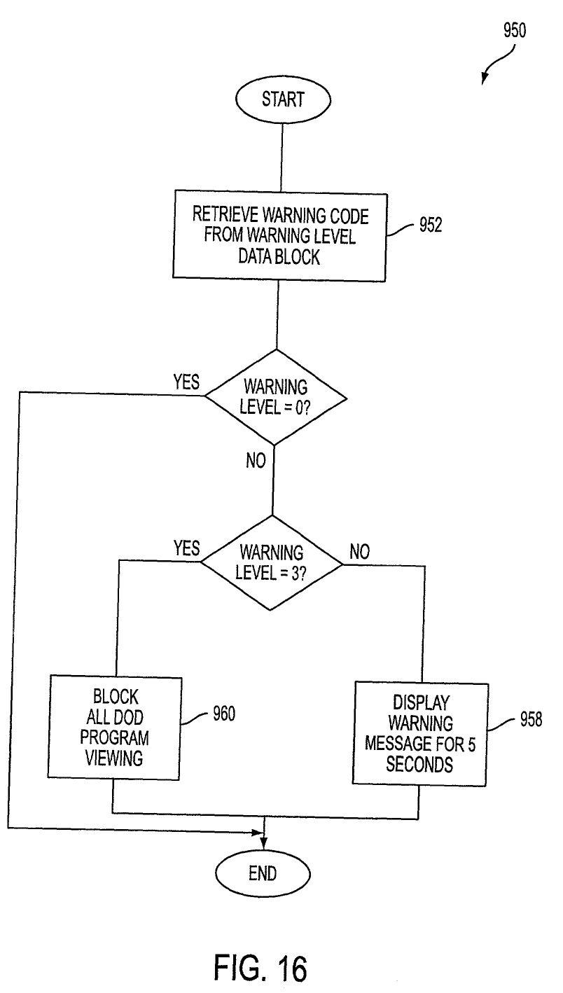

FIG. 16 shows a warning level display process at 950 in accordance with one embodiment of the present invention. The process begins at step 952, in which an STB 600 (FIG. 8) retrieves a warning level value 922 from the warning level data block 920 (FIG. 15) associated with STB 600. If the warning level value equals 0 the process ends and no warning message is displayed. If the warning value equals 3 the process continues to step 958, in which a warning message is displayed for a five second time interval whenever the STB 600 (FIG. 8) is turned “ON”. This warning message (not shown) could be a generic message or a client specific message stored in the memory 608 (FIG. 8). In one embodiment the message includes information indicating that the client's account is over due. In one embodiment the warning message includes a contact number or other information for remedying the account status. After five seconds the warning level message is no longer displayed and the STB functions normally.

If the warning level value 922 (FIG. 15) equals 3 the process continues to a step 960, in which a warning level message is displayed blocking any DOD program display. This warning level message is displayed continuously such that any DOD program being displayed is blocked from the view of a user. The warning message may include an amount due, a contact number or other information for remedying the account status.

The foregoing examples illustrate certain exemplary embodiments of the invention from which other embodiments, variations, and modifications will be apparent to those skilled in the art. The invention should therefore not be limited to the particular embodiments discussed above, but rather is defined by the following claims.

What is claimed is:

1. A method for controlling client access to DOD services comprising the acts of:
providing at least one subscription data packet including at least one client identification code and at least one subscription level code to at least one client; and
providing at least one service having at least one associated subscription level to said at least one client; wherein said at least one associated subscription level code indicates that said at least one client may access said at least one service.

2. A method as recited in claim 1, wherein said at least one associated subscription data packet is provided to said at least one client via a transmission medium.

3. A method as recited in claim 1, wherein said at least one subscription data packet includes at least one associated warning level code, indicating a warning for display to said at least one client.

4. A method as recited in claim 3, wherein at least a portion of said at least one service is displayed via a visual display device, and further wherein said displayed warning obscures at least a portion of said displayed service.

5. A method as recited in claim 1, further comprising the act of providing at least one additional subscription data packet including at least one superceding subscription level code and said client identification code, wherein said at least one superceding subscription level code enables said client to access additional services.

6. A method as recited in claim 1, wherein said client identification code is accessible by an associated client, and wherein said client identification code enables said associated client to access said at least one subscription level code.

7. A method as recited in claim 1, further comprising the act of accessing said service.

8. A method as recited in claim 7, wherein said act of accessing said service includes displaying at least a portion of said service visually.

9. A method as recited in claim 6, wherein said subscription level code is a binary number having a plurality of bits, each bit being associated with a corresponding DOD service.

10. A method as recited in claim 1, wherein said at least one subscription level code is indicative of at least one of a plurality of subscription levels of service.

11. A method for controlling client access to DOD services comprising the acts of:
receiving at least one subscription data packet including at least one associated client identification code and at least one associated subscription level code; and
storing at least a portion of said at least one associated subscription level code in a memory location;
receiving at least one service having at least one associated subscription level; and
wherein said at least one associated subscription level code corresponds to said at least one associated subscription level, accessing at least a portion of said service.

12. A method as recited in claim 11, further comprising receiving said at least one associated subscription level from an electronic program guide.

13. A method as recited in claim 11, wherein said subscription data packet includes an associated warning level code, displaying a warning message associated with said warning level code.

14. A method as recited in claim 11, wherein said at least one associated subscription level corresponds to at plurality of said at least one associated subscription level codes.

15. A method as recited in claim 11, further comprising the act of receiving an additional subscription data packet including at least one superceding subscription level code and said client identification code, wherein said at least one superceding subscription level code enables said client to access additional services.

16. A method as recited in claim 11, wherein said at least one client identification code is accessible by an associated client, and wherein said at least one client identification code enables said associated client to access said subscription level code.

17. A method as recited in claim 13, including displaying at least a portion of said service such that at least a portion of said displayed service is obscured by said warning message.

18. A method as recited in claim 11, wherein said act of accessing said at least one service includes storing at least a portion of said service to said memory location.

19. A method as recited in claim 11, wherein said at least one associated subscription level code is a binary number having a plurality of bits, each said bit being associated with at least one corresponding DOD service.

20. A method as recited in claim 11, wherein said at least one subscription level code is indicative of at least one of a plurality of subscription levels of service.

21. A data-on-demand (DOD) broadcasting system for providing DOD services to clients comprising:
a DOD server operative to provide at least one DOD program to clients via a transmission medium, said DOD server further operative to provide at least one subscription level code to said clients in order to enable at least one of said clients to access said at least one DOD program, wherein said at least one subscription level code is associated with said at least one DOD program, and further wherein said at least one subscription level code is accessed by one or more selected clients that are authorized to access said at least one DOD program associated with said at least one subscription level code.

22. A DOD broadcasting system as recited in claim 21, wherein said at least one subscription level code is provided to clients via said transmission medium.

23. A DOD broadcasting system as recited in claim 22, wherein said transmission medium includes electromagnetic signals in the general range of radio and television broadcasts.

24. A DOD broadcasting system as recited in claim 22, wherein said transmission medium includes a fiber optic network.

25. A DOD broadcasting system as recited in claim 21, wherein said DOD server is further operative to provide at least one client identity code associated with a selected client.

26. A DOD broadcasting system as recited in claim 21, wherein said transmission medium includes the Internet.

27. A DOD broadcasting system as recited in claim 25, wherein said client identity code enables an associated client to access said at least one subscription level code.

28. A DOD broadcasting system as recited in claim 27, wherein said at least one subscription level code enables said client to access said at least one DOD program.

29. A DOD broadcasting system as recited in claim 25, wherein said client identity code enables at least one associated set-top-box (STB) to access said at least one subscription level code.

30. A DOD broadcasting system as recited in claim 29, wherein said at least one subscription level code is indicative of at least one of a plurality of subscription levels of service and wherein each said DOD program is associated with at least one of said subscription levels of service.

31. A DOD broadcasting system as recited in claim 21, wherein said at least one subscription level code is provided to said at least one client as part of an information packet including said at least one subscription level code.

32. A DOD broadcasting system as recited in claim 31, wherein said information packet further includes a client identification code for enabling an associated set-top-box (STB) to access at least one DOD program associated with said subscription level code.

33. A DOD broadcasting system as recited in claim 32, wherein said information packet further includes a warning level indicative of at least one client account status.

34. A DOD broadcasting system as recited in claim 33, wherein said associated set-top-box (STB) displays a graphic representation of said warning level to said client.

35. A DOD broadcasting system as recited in claim 34, wherein said at least one DOD program is displayed to said client as a DOD program display.

36. A DOD broadcasting system as recited in claim 15, wherein said graphic representation of said warning level prevents at least a portion of said DOD program display from being viewed by said client.

37. A set-top-box (STB) for receiving data-on-demand comprising:
a databus;
a first communication device suitable for coupling to a digital broadcast communications medium, said first communication device operable to receive digital broadcast data;
memory bi-directionally coupled to said databus, said memory including computer executable instructions for:
a) reading at least a portion of said digital broadcast data, said digital broadcast data including a client identification code associated with said client and a subscription access level;
b) determining whether said client identification code included in said data is associated with said client; and
c) when said client identification code included in said data is determined to be associated with said client, implementing said subscription access level, wherein said implemented subscription access level enables said client to access at least one DOD program associated with said subscription access level;
a digital data decoder bi-directionally coupled to said databus; a central processing unit (CPU) bi-directionally coupled to said databus, said CPU implementing a STB control process controlling said memory, said first communications device and said digital decoder, said STB control process operable to process digital data received at said first communications device.

38. A STB as recited in claim 37, wherein said memory includes transient random access memory (RAM) and a persistent storage device, and said computer executable instructions are stored on said persistent storage device.

39. A STB as recited in claim 38, wherein said persistent storage device is a hard disk.

40. A STB as recited in claim 37, further comprising a hardware identification code hidden with the STB hardware, wherein said computer executable instructions include instructions for determining whether said client identification code is associated with said hardware identification code, and when said client identification code is determined to be associated with said hardware identification code enabling said STB to display an associated DOD program.

41. A STB as recited in claim 37, wherein said client has an account status and wherein said digital broadcast data includes a warning level associated with said account status.

42. A computer implemented method for controlling access to data-on-demand (DOD) programs by a data receiving system such as a set-top-box to, said computer implemented method comprising the act of:
transmitting to said data receiving system an information packet including a client identifier and a subscription level code, wherein said data receiving system is operative executable by said data receiving system, said anti-counterfeit software operable to determine whether said data receiving device is counterfeit or authentic, said anti-counterfeit software further operable to perform anti-counterfeit measures at said data receiving system.

43. A method as recited in claim 41, wherein said account status is indicative of an amount owed to a service provider and a last payment date.

44. A data packet comprising:
at least one client data block including an associated client identification number corresponding to a client; and
at least one subscription level data block including at least one associated subscription level code indicating at least one subscription level associated with said client.

45. A data packet as recited in claim 44, wherein said subscription level data block is partitioned into a plurality of bits, wherein each said bit corresponds to an associated level of service.

46. A data packet as recited in claim 44, further comprising at least one warning level data block including at least one warning level code indicating a warning level associated with said client.

47. A data packet as recited in claim 44, further comprising at least one service level data block including at least one service level code indicating at least one service said client may access.

48. A method for controlling client access to DOD services comprising the acts of:
receiving at least one subscription data packet including at least one associated client identification code, at least one associated subscription level code, and at least one associated service level code; and
storing at least a portion of said at least one associated subscription level code in a memory location;
storing at least a portion of said at least one associated service level code in a memory location;
receiving at least one first service having at least one associated subscription level; and
wherein said at least one associated subscription level code corresponds to said at least one associated subscription level, accessing at least a portion of said first service.

49. A method as recited in claim 48, further comprising:
receiving at least one second service having at least one associated service level; and
wherein said at least one associated service level code corresponds to said at least one associated service level, accessing at least a portion of said second service.

50. A method as recited in claim 48, wherein said subscription data packet includes an associated warning level code, displaying a warning message associated with said warning level code.

51. A method as recited in claim 48, wherein said at least one associated subscription level corresponds to at plurality of said at least one associated subscription level codes.

52. A method as recited in claim 48, further comprising the act of receiving an additional subscription data packet including at least one superceding subscription level code and said client identification code, wherein said at least one superceding subscription level code enables said client to access additional services.

53. A method as recited in claim 48, wherein said at least one client identification code is accessible by an associated client, and wherein said at least one client identification code enables said associated client to access said subscription level code.

54. A method as recited in claim 50, including displaying at least a portion of said first service such that at least a portion of said displayed service is obscured by said warning message.

55. A method as recited in claim 48, wherein said act of accessing said at least one first service includes storing at least a portion of said first service to said memory location.

56. A method as recited in claim 48, wherein said at least one associated subscription level code is a binary number having a plurality of bits, each said bit being associated with at least one corresponding DOD service.

57. A method as recited in claim 48, wherein said at least one subscription level code is indicative of at least one of a plurality of subscription levels of service.

58. A method as recited in claim 49, wherein said act of accessing said at least one second service includes storing at least a portion of said second service to said memory location.
